(19) United States
(12) Patent Application Publication
(10) Pub. No.: US 2008/0204777 A1
(43) Pub. Date: Aug. 28, 2008

(54) IMAGE PROCESSING CIRCUIT AND PRINTER CONTROLLER EQUIPPED WITH THE SAME

(75) Inventor: Kanji TAKEMATSU, Nagano-ken (JP)

Correspondence Address: SUGHRUE-265550, 2100 PENNSYLVANIA AVE. NW, WASHINGTON, DC, 20037-3213, US

(73) Assignee: SEIKO EPSON CORPORATION, Tokyo (JP)

(21) Appl. No.: 12/033,129

(22) Filed: Feb. 19, 2008

(30) Foreign Application Priority Data
Feb. 16, 2007 (JP) 2007-036774

(51) Int. Cl. G06K 15/02

(52) U.S. Cl. 358/1.9; 358/1.16

(57) ABSTRACT

An image processing circuit divides input image data having gradation values for each pixel into cells formed from a plurality of pixels and performs screen processing on a per-cell basis, to thus convert the input image data into output image data. The image processing circuit includes: a cell screen processing circuit, configured to extract from the input image data a cell in a predetermined shape, to determine a position of centroid of a gradation value in the cell from input gradation values of respective pixels constituting the cell, and to perform screen processing for deciding output gradation values of the respective pixels; an output raster buffer, configured to store the output gradation values of the respective pixels; a raster buffer write controller, configured to perform processing for writing the output gradation values of the respective pixels into the output raster buffer; and a raster buffer read controller, configured to perform processing for reading and outputting the output gradation values of the respective pixels written into the output raster buffer.

### BACKGROUND

1. Technical Field

The present invention relates to an image processing circuit that performs screen processing on a per-cell basis, as well as to a printer controller equipped with the image processing circuit.

2. Related Art

In a related image processor, such as a printer, input image data having a multivalued gradation value for each pixel is converted into output image data having a smaller number of gradation levels (e.g., a binary) through halftone processing, and the data is printed on a print sheet.

Various methods are available for half tone processing. For instance, there is a dot-concentrated dithering method (a multi valued dithering method). According to the multivalued dithering method, threshold values are distributed within a matrix of predetermined size in such a way that a dot grows from the center of the matrix, and processing is performed by comparison of the threshold value with an input gradation value of each pixel.

There is also processing that is to repeatedly apply a screen cell of predetermined geometrical pattern consisting of a plurality of pixels in such a way that an image having a multivalued gradation value is covered with the screen cells and to cause dots to grow in the screen cell in predetermined order in association with an increase in gradation value. During processing, an output gradation value corresponding to an input gradation value of a pixel is determined by use of a multivalued dithering matrix (an index table) that consists of index values corresponding to respective pixels in a screen cell and indicating gamma table numbers and a gamma table that indicates correspondence between input gradation values and output gradation values of the respective pixels, and by reference to the gamma table showing index values corresponding to the respective pixels.

In order to attain both a gradation characteristic and high resolution, JP-A-2006-325136 describes a method (hereinafter referred to as “AAM (Advanced AM screen) method”) for determining the position of centroid from gradation values of respective pixels in a screen cell consisting of a plurality of pixels and causing a dot corresponding to a sum of gradation values of the respective pixels to grow at the position of centroid. Further, in relation to the AAM method, a method for solving a drawback, such as blurring of an output image resulting from narrow lines in the cells being grouped as a circular dot is described in JP-A-2006-325136.

The cell screen processing mentioned above is generally implemented by software, and the processing is performed while image data equivalent of one page (e.g., about 35 Mbytes for a monochrome A4-size image of 600 dpi) are stored in memory such as RAM. However, when similar cell screen processing is performed by means of hardware, ensuring in an LSI memory for storing image data equivalent of one page is not realistic in terms of cost or the like.

### SUMMARY

An advantage of some aspects of the invention is to provide a technique for performing cell screen processing by means of hardware by use of an output raster buffer having small capacity for storing a result of the cell screen processing.

According to an aspect of the invention, there is provided an image processing circuit, adapted to be provided in a printer controller, and operable to divide input image data having gradation values for each pixel into cells formed from a plurality of pixels and to perform screen processing on a per-cell basis, to thus convert the input image data into output image data, the image processing circuit comprising:

a cell screen processing circuit, configured to receive an input of the input image data, to extract from the input image data a cell in a predetermined shape, to determine a position of centroid of a gradation value in the cell from input gradation values of respective pixels constituting the cell, and to perform screen processing for deciding output gradation values of the respective pixels so as to cause a dot corresponding to a total of the input gradation values of the entire cell to grow, with reference to the position of the centroid, thereby outputting the output gradation values of the respective pixels;

an output raster buffer, configured to store the output gradation values of the respective pixels having been subjected to the screen processing;

a raster buffer write controller, configured to perform processing for writing the output gradation values of the respective pixels having been subjected to the screen processing, into the output raster buffer; and

a raster buffer read controller, configured to perform processing for reading and outputting the output gradation values of the respective pixels written into the output raster buffer.

The present disclosure relates to the subject matter contained in Japanese patent application No. 2007-036774 filed on Feb. 16, 2008, which is expressly incorporated herein by reference in its entirety.

### BRIEF DESCRIPTION OF THE DRAWINGS

The invention will be described with reference to the accompanying drawings, wherein like numbers reference like elements.

FIG. 1 is a view showing the configuration of a printer controller to which the present invention applies.

FIG. 2 is a block diagram for describing the configuration of an image processing circuit and a data flow.

FIG. 3 is a view showing an example where a screen cell is applied to an input image.

FIG. 4 is a descriptive view of a method for computing an output gradation value of a shared pixel.

FIG. 5 is a descriptive view of cell screen processing with respect to input image data.

FIG. 6 is a block diagram for describing the configuration of an output processing circuit and a data flow of a first embodiment.

FIG. 7 is a descriptive view of processing using an output raster buffer of the present invention.

FIG. 8 is a block diagram for describing the configuration of an output processing circuit and a data flow of a second embodiment.

FIG. 9 is a block diagram for describing the configuration of an output processing circuit and a data flow of a third embodiment.

### DESCRIPTION OF EXEMPLARY EMBODIMENTS

The exemplary embodiments for practicing the present invention will be described by reference to the drawings.

When a screen cell having an asymmetric shape is iteratively applied so as to cover an image having a multivalued gradation value with the screen cells by means of a processing method using a screen cell, there arises a problem of occurrence of noise. For this reason, the present invention will be described by means of taking, as an example, a method for making the shape of a cell symmetrical by means of sharing pixels located along a periphery of the cell with a plurality of other adjacent cells. An overview of the method will be provided below.

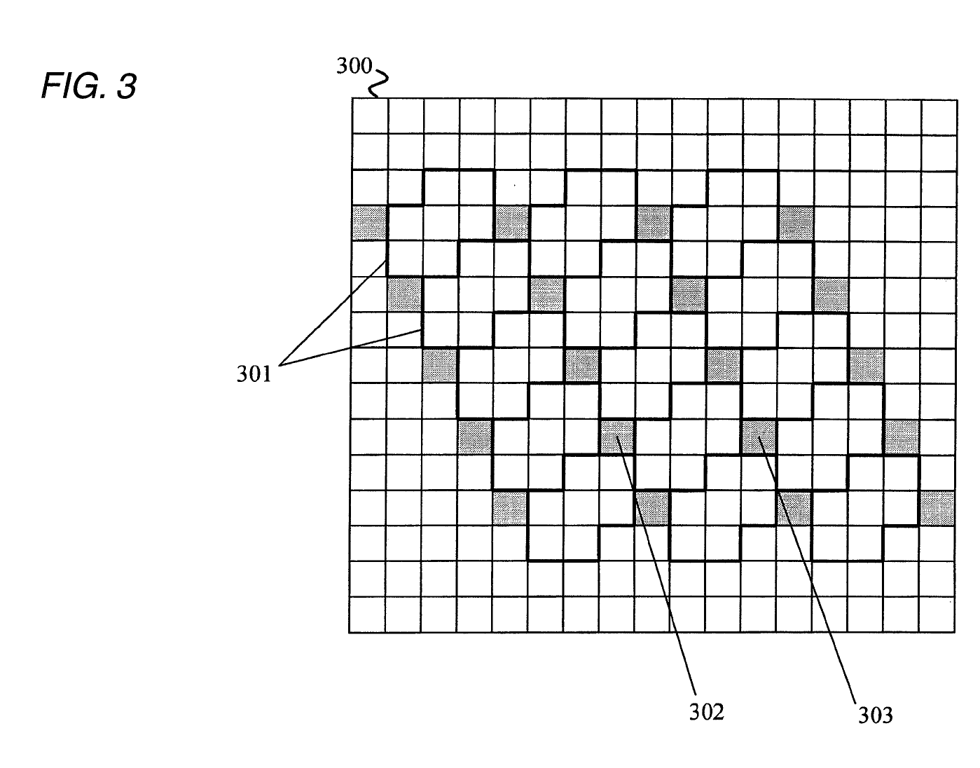

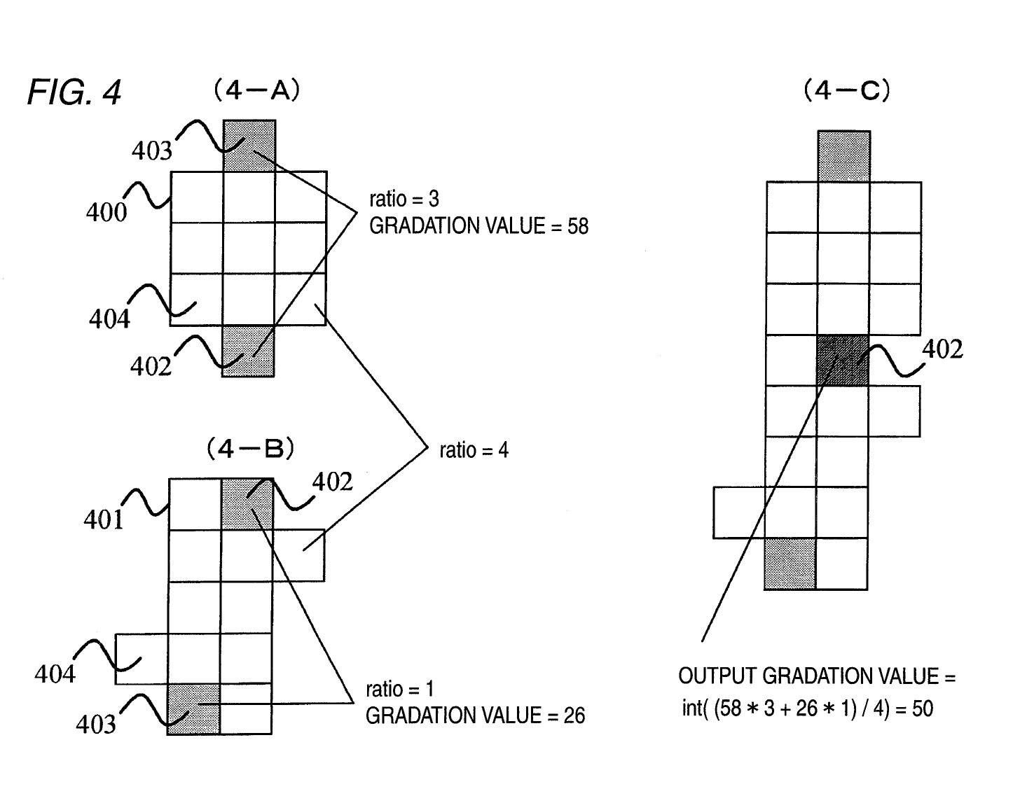

FIG. 3 is a view showing an example where a screen cell is repeatedly applied to an input image. FIG. 4 is a view showing an example method for computing an output gradation value when pixels located along a periphery of a cell are shared with other cells.

As shown in FIG. 3, for instance, when a screen cell whose shape is analogous to that of a screen cell 301 is applied, pixels which are not incorporated into any cells, such as a pixel-A 302 and a pixel-B 303, are present. All pixels of an input image can be subjected to screen cell processing by application of a screen cell whose shape incorporates either the pixel-A 302 or the pixel-B 303. However, since the shape of the screen cell achieved in this case is asymmetrical, noise may arise in an output image.

For this reason, the pixel-A 302 and the pixel-B 303 are shared between adjacent screen cells. As a result, shapes of the screen cells become symmetrical, and the potential for occurrence of noise in an output image can be diminished.

A method for computing output gradation values for implementing sharing of pixels will now be described by reference to FIG. 4. In an embodiment shown in FIG. 4, screen processing performed when a cell-A 400 (see FIG. 4-A) and a cell-B 401 (see FIG. 4-B), which differ from each other in terms of a shape, are used, is described, but the present invention is not limited to the embodiment. Cells of the same shape may also be used as shown in FIG. 3. Processing of shared pixels is performed by use of a result, which is achieved by subjecting respective cells to screen processing, and proportional division of gradation values of shared pixels in the respective cells. Specifically, processing is performed as follows.

A value (ratio) showing a shared level is designated with regard to each of pixels constituting a cell. Here, the term “ratio” designates a value that shows an output ratio in each cell of a shared pixel. In FIG. 4, a ratio assuming a value of three is applied to shared pixels 402 and 403 of the cell-A 400. Moreover, a ratio assuming a value of one is applied to shared pixels 402 and 403 of the cell-B 401. A ratio assuming a value of four is applied to unshared pixels 404 of the cell-A 400 and the cell B-401. The value of four is the maximum value (hereinafter called a “maxratio”). The value of “ratio” can be set or changed according to the shape of a cell or the like.

For instance, a gradation value of the shared pixel 402 of the cell A-400 is assumed to be 58, and a gradation value of the shared pixel 402 of the cell-B 401 is assumed to be 26. In this case, an output gradation value of the shared pixel 402 can be determined as follows (see FIG. 4-C): {int((58*3+26*1)/4)=50).

The method for sharing the pixel between a plurality of adjacent cells has been described thus far. The present invention can also be applied to cell screen processing which does not involve sharing of a pixel.

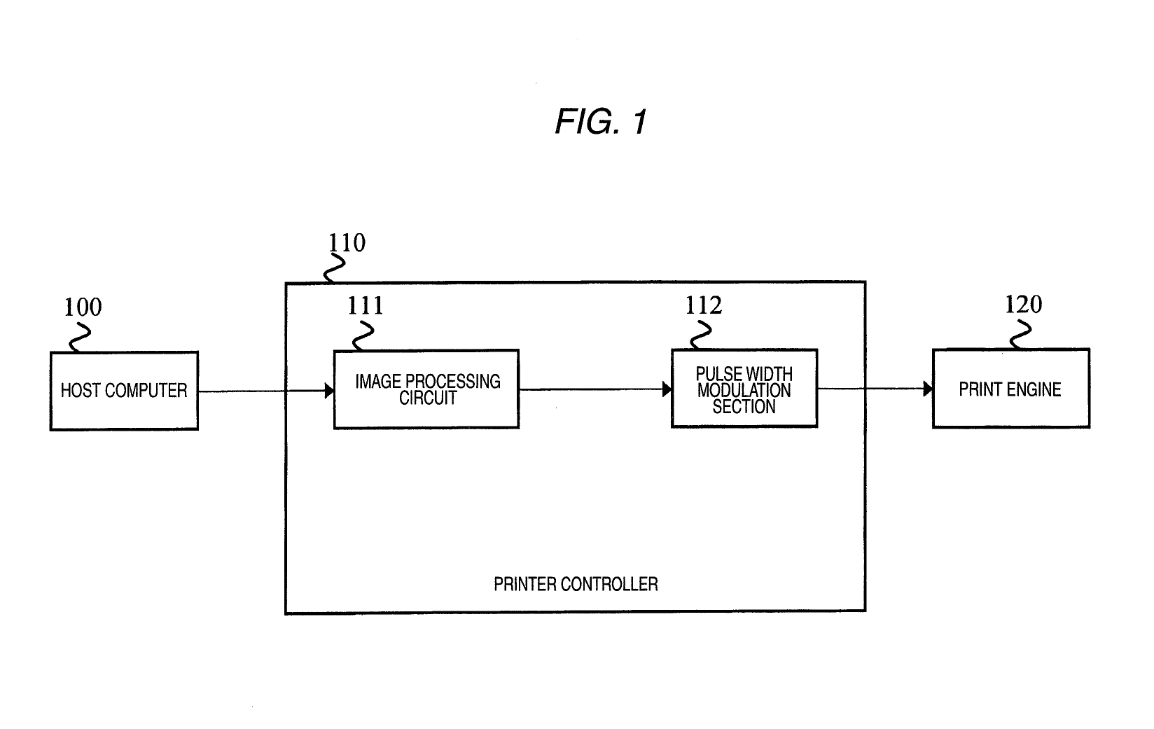

FIG. 1 is a view showing a general configuration of a printer controller to which the present invention applies. A printer controller 110 is connected to a host computer 100 by way of; for example, an unillustrated interface. A print engine 120 which outputs data generated by the printer controller 110 is also connected.

The host computer 100 generates data to be printed, for example, character data or graphic data by means of an application program. On the occasion of printing, image data generated by rasterization of the data to be printed are output to the printer controller 110.

The printer controller 110 has an image processing circuit 111 and a pulse width modulation section 112. The image processing circuit 111 receives the input image data inputted by way of the host computer 100 and subjects the data to, for example, cell screen processing or halftone processing using an index table and a gamma table (cell screen processing and halftone processing are hereinafter collectively called cell screen processing). During cell screen processing, output image data converted into data (an output gradation value) indicating the width of a rendering laser pulse, for instance, are generated for each of pixels of the input image data, and the thus-generated output image data are output to the pulse width modulation section 112. The pulse width modulation section 112 generates a laser pulse width signal corresponding to the input data, and the signal is output to a print engine 120. The print engine 120 subjects a print sheet to printing in accordance with the input laser pulse width signal. In the case of, for example, a laser printer, the print engine 120 includes a laser radiation mechanism, a photosensitive drum, a sheet feeding mechanism, and the like.

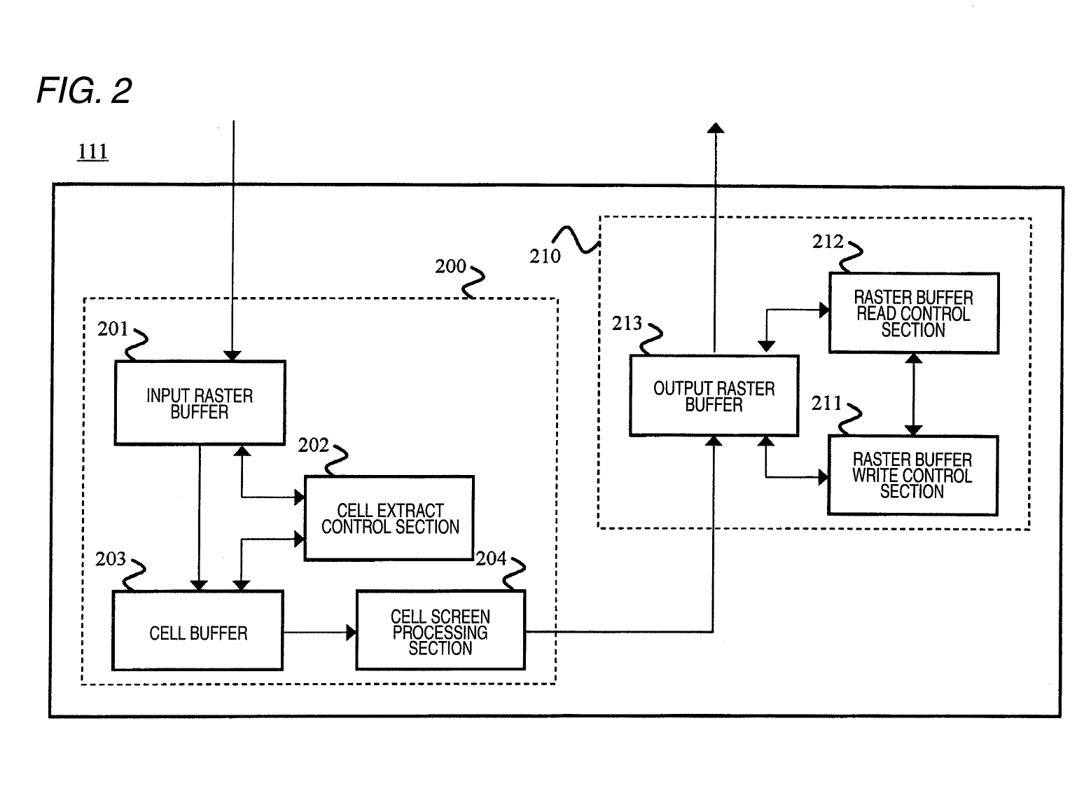

An image processing circuit 111 that performs cell screen processing of the present invention will now be described. FIG. 2 is a block diagram for describing the configuration of the image processing circuit 111 and the flow of data.

The image processing circuit 111 includes a, cell screen processing circuit 200 and an output processing circuit 210. The cell screen processing circuit 200 has an input raster buffer 201, a cell extract control section 202, a cell buffer 203, and a cell screen processing section 204. The output processing circuit 210 includes a raster buffer write control section 211, a raster buffer read control section 212, and an output raster buffer 213.

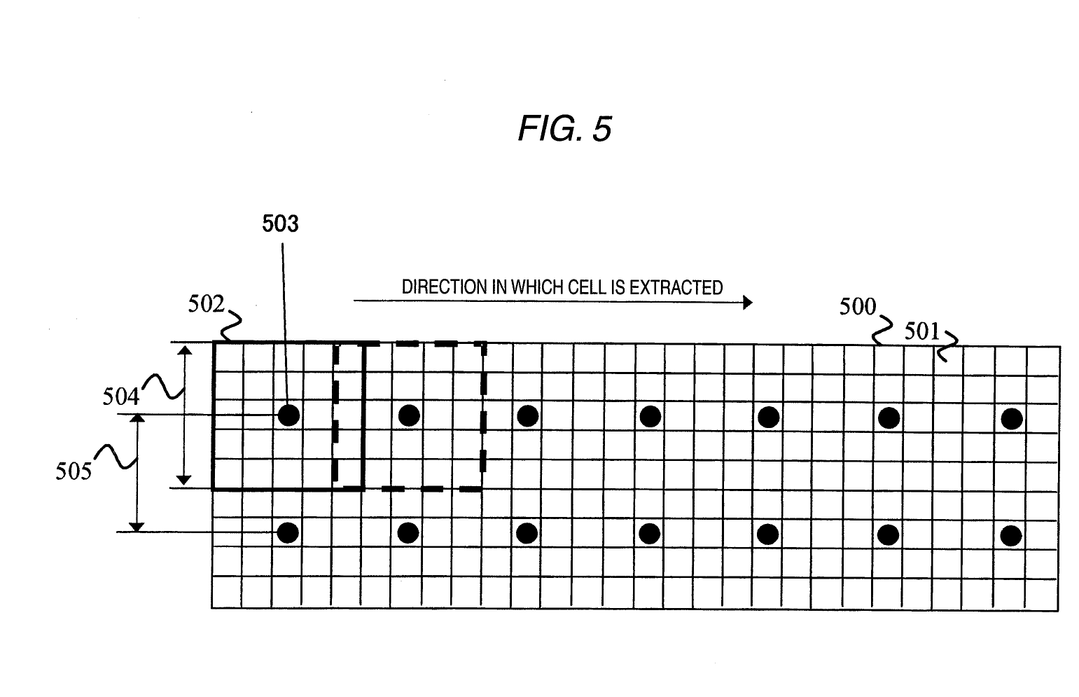

The input raster buffer 201 is memory with a built-in hardware logic circuit which receives an input of input image data and which stores input gradation values of respective pixels. For instance, dual port DRAM, dual port SRAM, and the like, is used. As shown in FIG. 5, input image data 500 that have been input by way of the host computer 100 and that are built from a plurality of pixels 501 are stored. Input gradation values of respective pixels are stored at addresses corresponding to respective pixels 501.

The cell extract control section 202 extracts a cell of predetermined shape from the input image data 500 stored in the input raster buffer 201 and stores the thus-extracted cell into the cell buffer 203. The cell buffer 203 has, for example, two plane areas. During the course of the cell screen processing section 204 reading and processing one of the areas, processing for writing the next extracted cell into the other area is performed. As shown in FIG. 5, for instance, processing for extracting a cell 502 sequentially proceeds in a rightward direction (the direction of a raster).

Although an area of 5-by-5 pixels is illustrated in FIG. 5 as the cell 502 for the sake of explanation, cells of various shapes and sizes centering on respective cell centers 503 are applicable. Further, in the embodiment shown in FIG. 5, an overlap appears to exist between a row of cells in a direction where a cell is extracted (i.e., the direction of a raster). However, in order to facilitate comprehension of explanations, descriptions are provided on condition that the shape of a cell avoiding sharing of a pixel is applied to a row of cells adjacent to each other in the direction where a cell is extracted. An arrangement of a plurality of cells in the direction of a raster is assumed to be called a cell row (a raster row in the case of a raster), and an arrangement of cells in a direction perpendicular to the direction of a raster is assumed to be called a cell column (a raster column in the case of a raster). In adjacent cell rows, a distance between the centers of cells is called a vertical shift. For instance, in FIG. 5, reference numeral 505 designates a vertical shift.

The cell screen processing section 204 performs processing for determining, from input gradation values of respective pixels in a cell made up of the plurality of pixels, the position of centroid of a gradation value in the cell and causing a dot corresponding to the sum of the gradation values of the respective pixels to grow while taking the position of centroid as a reference.

Specifically, the cell screen processing section 204 first computes the position of centroid from coordinates of pixels constituting a cell stored in the cell buffer 202, input gradation values of the respective pixels, and a total of the input gradation values in the cell. Next, an output gradation value is computed and output in order from a pixel closest to the position of centroid through use of a multivalued dithering matrix and a gamma table while the total of input gradation values of the entire cell is maintained.

The output raster buffer 213 is memory built in a hardware logic circuit for storing output gradation values of respective pixels output from the cell screen processing section 204. For instance, dual-port DRAM, dual-port SRAM, and the like, is used.

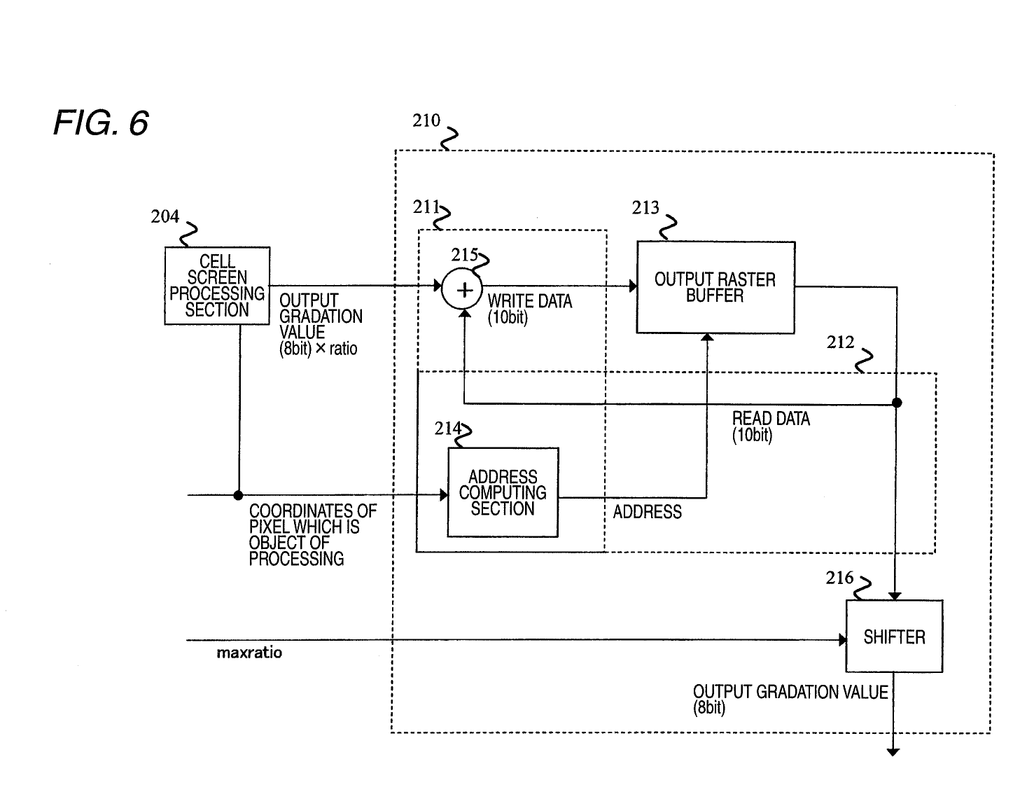

The raster buffer write control section 211 performs write processing for writing the output gradation values of the respective pixels output from the cell screen processing section 204 into the output raster buffer 213. When a pixel, which is an object of write processing, is a shared pixel, there is performed computation for determining an output gradation value of the pixel by use of the gradation value output from the cell screen processing section 204 and a gradation value read by the raster buffer read control section 212, and a result of computation is written into the output raster buffer 213. The raster buffer read control section 212 performs processing for reading the output gradation values of the respective pixels written into the output raster buffer 213 and outputting the thus-read output gradation values to another circuit, for example, the pulse width modulation section 112. The raster buffer write control section 211 and the raster buffer read control section 212 has an address computing section 214 (see FIG. 6) for determining an address that is to serve as a write position and a read position. In the present embodiment, the address computing section 214 is shared between the raster buffer write control section 211 and the raster buffer read control section 212. As a matter of course, the layout is not limited to this configuration, and there can also be adopted a configuration in which the raster buffer write control section and the raster buffer read control section are provided with address computing sections, respectively.

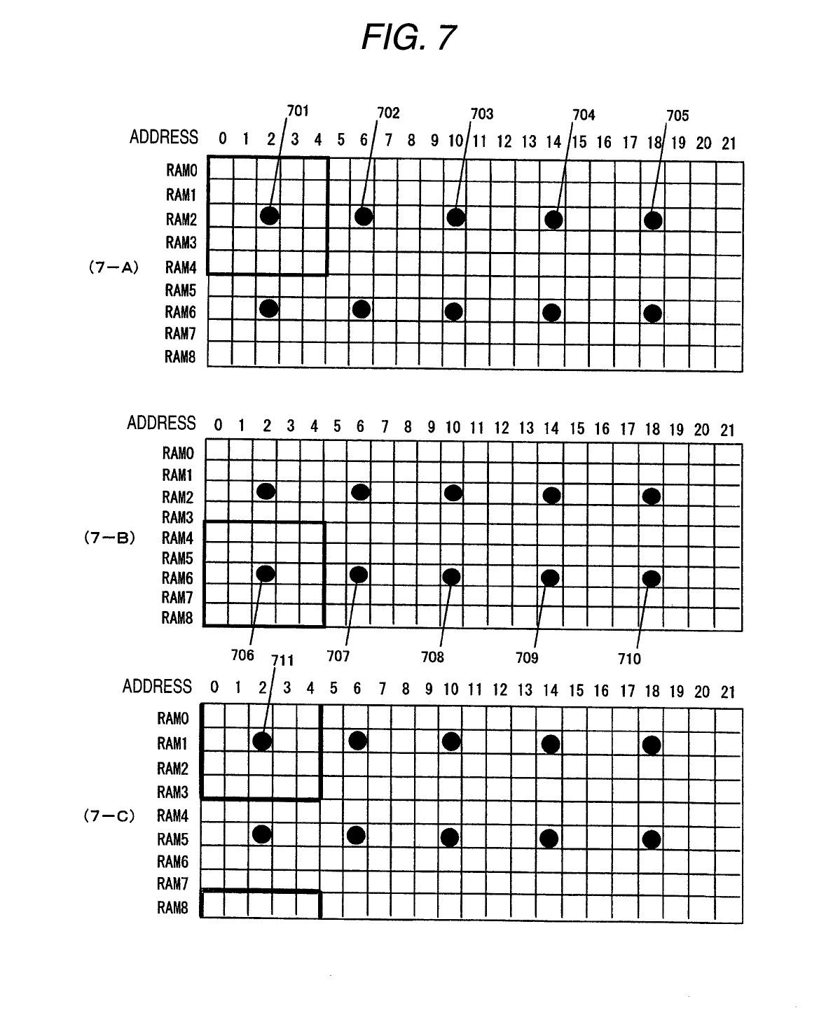

Next, the output processing circuit 210 using an output raster buffer of the present invention will be described specifically. FIG. 6 is a view for describing the configuration of the output processing circuit 210 and the flow of data which pertain to the first embodiment. FIG. 7 is a view for describing processing using output raster buffers of first through third embodiments.

By reference to FIGS. 6 and 7, operation of the output processing circuit 210 using the output raster buffer of the first embodiment will be described. In FIG. 7, for the sake of explanation, an area of 5-by-5 pixels is illustrated as a cell as in FIG. 5. However, cells of various shapes and sizes centered on the cell center 701 are applicable. In the embodiment shown in FIG. 7, an overlap appears to exist between a row of cells arranged in a lateral direction (the direction of a raster). However, in order to facilitate comprehension of explanations, descriptions are provided on condition that the shape of a cell avoiding sharing of a pixel is applied to a row of cells adjacent to each other in the direction of a raster.

As shown in FIG. 6, the cell screen processing section 204 performs screen processing on a per-cell basis and outputs, in order from a pixel whose output gradation value is determined, a value determined by multiplication of an output gradation value of the pixel by the “ratio.” Coordinate values of a pixel which is an object of processing are also output.

The raster buffer write control section 211 performs processing for writing a gradation value received from the cell screen processing section 204 into an address computed by the address computing section 214. The raster buffer read control section 212 performs processing for reading, from the address computed by the address computing section 214, gradation values of respective pixels on a per-raster-row basis in the direction of a raster. Further, processing for reading gradation values of respective pixels of the designated addresses is performed.

The raster buffer write control section 211 also performs processing for determining whether or not the pixel to be processed indicated by the address computed by the address computing section 214 is a shared pixel. When the pixel to be processed is determined to be a shared pixel, the address computed by the address computing section 214 is reported to the raster buffer read control section 212, thereby reading a gradation value of the pixel. The raster buffer write control section 211 performs processing for writing, into the address reported by the address computing section 214, a value determined by addition of a gradation value received from the cell screen processing section 204 and a gradation value reported from the raster buffer read control section 212. When the pixel to be processed is determined not to be a shared pixel, there is performed processing for writing, into the address computed by the address computing section 214, the gradation value received from the cell screen processing section 204.

The address computing section 214 receives, for example, coordinates of the pixel to be processed in the cell from the cell screen processing section 204, and receives, from the unillustrated cell extract control section 202, coordinates of the cell in the input image data stored in the input raster buffer 201. An address in the output raster buffer 213 where the pixel to be processed is to be written is computed from values of the two coordinates.

The address computing section 214 manages a position in the output raster buffer 213 where writing of a cell row (a raster row) is started. For instance, as shown in FIG. 7, (RAM 0: Address 0) is stored in (7-A). When processing of the cell row is completed, (RAM 4: Address 0) to which the vertical shift level 4 is added is stored. After processing of the cell row (see 7-B) is completed, (RAM 8: Address 0) to which the vertical shift level 4 is added is stored. After processing of the cell row is completed, a position next to be stored comes to (RAM 3: Address 0) because the number of raster rows of the output raster buffer 213 is nine (see 7-C). Management is similarly performed after that. When processing of cells in a cell row is performed from the write start position, there are occasions when a part of a plurality of raster rows constituting the cell row come to a position which exceeds the final raster row of the output raster buffer 213. In this case, pixels of the raster rows are processed from the first raster row of the output raster buffer 213. For instance, as shown in FIG. 7, a write start position of a cell 11 (a cell centered on a cell center 711) comes to (RAM 8: Address 0) in (7-C). However, four raster rows exceed the final raster row (RAM 8) of the output raster buffer 213. Accordingly, when pixels located at coordinates in the four raster rows are processed, the address computing section 214 computes address (RAM 0 to 3).

As mentioned above, the address computing section 214 determines an address where a gradation value of each pixel is written, through use of coordinate values, a write start position, and the position of a final raster row. Likewise, a read start position is managed in a similar way of a read position of a processed raster row. Write processing of the raster buffer write control section 211 and read processing of the raster buffer read control section 212 are performed simultaneously. The number of raster rows of the output raster buffer is exemplified as nine, and the vertical shift level of a cell row is exemplified as four. However, the present invention is not limited to these numbers. The shape of the cell, the size of the raster buffer, and the like, can be modified as appropriate.

Specific write processing and read processing will be described by reference to FIG. 7. First, the raster buffer write control section 211 writes data into respective pixels of a cell 1 (a cell centered on the cell center 701, and the same also applies to another cell) (see 7-A). At this time, a value determined by multiplying a gradation value by a maxratio (which is assumed to be four in the present embodiment) is written into an unshared pixel (e.g., RAM 1: Address 1, or RAM 0: Address 3). With respect to a shared pixel (e.g., RAM 4: Address 3), a value determined by multiplying a gradation value by the ratio (e.g., three in the present embodiment) of the pixel of the cell 1 is written. Likewise, the processing is performed to cells 2 to 5 in the same cell row. During a period in which processing is performed to the cell 2 to the cell 5, data pertaining to the cell 1 are stored in the output raster buffer 213. When processing of the cell 1 to the cell 5 is completed, data written in a range from RAM 0 to 3: Addresses 0 to 21 do not include a shared pixel, and hence the data can be output.

Next, the output raster buffer read control section 212 reads the data that fall within the range from RAM 0 to 3: Addresses 0 to 21 and that can be output (see 7-B). A read order is on a per-raster-row basis in the direction of a raster; namely, RAM 0: Addresses 0 to 21 and RAM 1: Addresses 0 to 21. The same also applies to RAM 2 and RAM 3. A value of 0 is written into the address where reading of data has been completed. The shifter 216 divides the thus-read data by the maxratio, and a result of division is output as an output gradation value to a processing circuit in the next stage.

In tandem with outputting of data, write processing is performed on a per-cell basis to cells 6 to 10, as well. When processing is performed to a shared pixel (e.g., RAM 4: Address 3), data pertaining to the pixel in the already-written cell 1 are read by use of the output raster buffer read control section 212. A value determined by multiplying a gradation value by a ratio (which is assumed to be one in the present embodiment) of the pixel in the cell 6 is added to the read data, and a result of addition is written. Addition is performed by an adder 215. In connection with an unshared pixel (e.g., RAM 8: Address 3, RAM 7: Address 0), a value determined by multiplying a gradation value by the maxratio is written. Processing is similarly performed to a cell 7 to a cell 10, as well. During the course of processing being performed to the cell 7 to the cell 10, data pertaining to the cell 6 are stored in the output raster buffer 213. When processing of the cell 6 to the cell 10 is completed, the data written into the range from RAM 4 to 7: Addresses 0 to 21 have already finished undergoing processing with respect to both the unshared pixels and the shared pixels, and hence the data can be output.

The output raster buffer read control section 212 reads the data in the range from RAM 4 to 7: Addresses 0 to 21 that have become able to output (see 7-C), and outputs the thus-read data. Further, in tandem with outputting of the data, write processing is performed on a per-cell basis to cells subsequent to the cell 11. Write processing is performed with respect to RAM 8: Addresses 0 to 21 and RAM 0 to 3: Addresses 0 to 21. Similarly, write processing and read processing are simultaneously performed after that.

The image processing circuit of the first embodiment using an output raster buffer has been described. Processing is described as being performed in order from the cell 1 to the cell 5. However, processing may also be performed in order of the cell 1, the cell 5, the cell 2, the cell 3, and the cell 4. When an output raster buffer of the present embodiment is implemented, the capacity of memory comes to, for example, {(8192 words)*(10 bits)*(nine rows)=(720 kbits)}. The reason for 10 bits is because two bits are required in order to multiply an 8-bit gradation value by the ratio (1 to 4 in this case). Such a configuration results in cell screen processing being realized by hardware and obviates a necessity for large-capacity memory (for storing image data equivalent of, e.g., one page) to be provided in an LSI. Significant cost reduction can be attained. Moreover, a reduction in power consumption can be attained by means of a reduction in memory capacity.

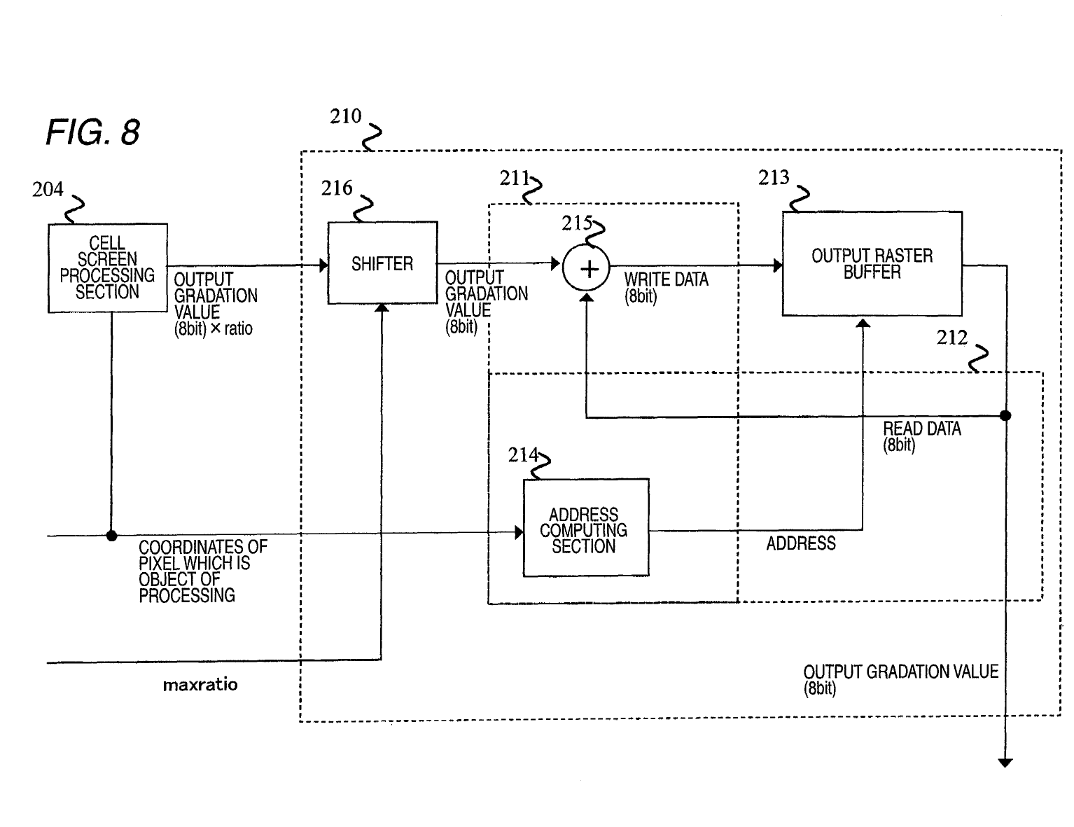

By reference to FIGS. 7 and 8, an image processing circuit using an output raster buffer of a second embodiment will be described primarily in connection with a difference between the first embodiment and the second embodiment. FIG. 8 is a view for describing the configuration of an output processing circuit 210 and the flow of data of the second embodiment.

As shown in FIG. 8, in the second embodiment, the shifter 216 is placed in a stage subsequent to the cell screen processing section 204. The shifter 216 divides a value, which has been determined by multiplying a gradation value of each pixel output from the cell screen processing section 204 by the ratio, by the maxratio. Specifically, data written into the output raster buffer 213 are determined as {(a gradation value of each pixel)*(ratio of each pixel)/(maxratio)}. The data read from the output raster buffer 213 serve, as they are, an output gradation value. Since the second embodiment is analogous to the first embodiment in terms of other processing, its explanation is omitted.

In the present embodiment, a shifter is used as a dividing circuit, and a fractional portion of a result determined by dividing a product by the maxratio is dropped. For this reason, an output gradation value of a shared pixel may differ between the first embodiment and the second embodiment.

For instance, the cell A and the cell B are assumed to share a pixel, and a gradation value of the shared pixel in the cell A is assumed to be 58, and a ratio of the shared pixel in the cell A is assumed to be three. A gradation value of the shared pixel in the cell B is assumed to be 26, and a ratio of the shared pixel in the cell B is assumed to be one. A value of maxratio is assumed to be four. An output gradation value of the shared pixel of the first embodiment comes to {int((58*3/4+26*1)/4)=50}, and an output gradation value of the shared pixel in the second embodiment comes to {int(58*3/4)+int(26*1/4)=49}.

However, acquiring output gradation values by means of directly one-to-one conversion of all input 255 gradation levels (eight bits) is not performed during cell screen processing. For instance, high-order six bits of eight bits are significant as output gradation values, and low-order two bits are expanded for the sake of convenience of processing. Therefore, a difference between the output gradation value of the first embodiment and the output gradation value of the second embodiment does not affect a result of actual printing.

The image processing circuit using an output raster buffer of the second embodiment has hitherto been described. By means of such a configuration, the capacity of the output raster buffer of the first embodiment can be reduced by about 20% {(8192 words*10 bits*nine rows)−(8192 words*8 bits*nine rows)=144 kbits}. As a result, further cost reduction and a further reduction in power consumption can be realized.

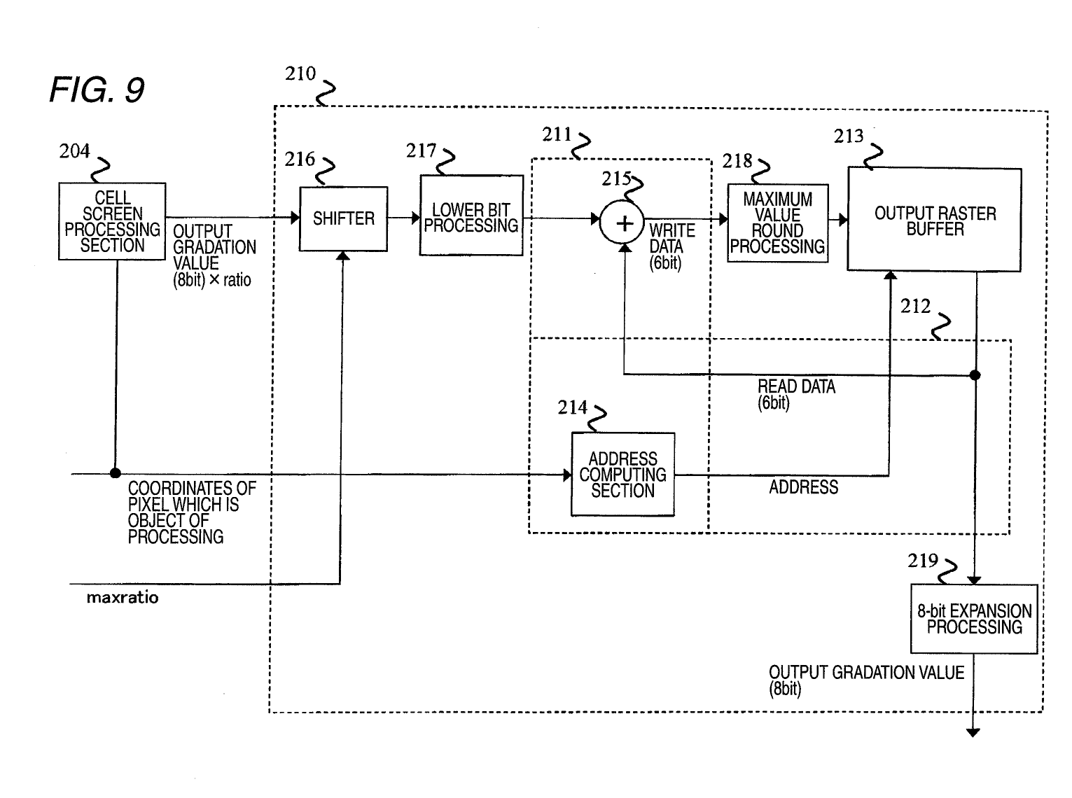

A third embodiment will be described by reference to FIGS. 7 and 9. An image processing circuit using an output raster buffer will be described primarily in connection with a difference between the second embodiment and the third embodiment. The third embodiment is intended for writing high-order six bits having a significance as an output gradation value into the output raster buffer 213. FIG. 9 is a view for describing the configuration of the output processing circuit 210 and the flow of data of the third embodiment.

As shown in FIG. 9, lower bit processing 217 is performed at a stage subsequent to the shifter 216 in the third embodiment. Maximum value round processing 218 is performed before writing of data into the output rater buffer 213. Data read from the output raster buffer 213 are subjected to 8-bit expansion processing 219.

The shifter converts 8 bits into 6 bits by means of lower bit processing 217. Further, round-off processing is performed at the time of shift processing. The reason for this is that there may arise a case where a low-order bit is dropped as a result of 8 bits being converted into 6 bits by means of the shifter, to thus cause an error in a gradation value written into the output raster buffer 213. For instance, in a case where a result of addition of a gradation value of a shared pixel should come to the maximum value, a result of computation may fail to come to the maximum value. In order to address such a case, a bit to be dropped is rounded off simultaneously with performance of lower bit processing. There is provided the maximum value round processing 218 for rounding a result of addition to the maximum value when a result of addition exceeds the maximum value. Data read from the output raster buffer 213 are subjected to 8-bit expansion processing 219. This is for causing the data to match an input format of a processing circuit in the next stage. Since the third embodiment is analogous to the first and second embodiments in terms of other processing, its explanation is omitted.

The above relates to the third embodiment. The image processing circuit using the output raster buffer has been described. By means of adoption of such a configuration, the capacity of the output raster buffer of the first embodiment can be reduced by about 40% {(8192 words*10 bits*nine rows)−(8192 words*6 bits*nine rows)=288 kbits}. As a result, further cost reduction and a further reduction in power consumption can be realized.

The present invention has been described in association with the illustrative embodiments. It is manifest that many alternatives, corrections, and modifications of the invention are obvious to skilled artisans. Therefore, the embodiments of the present invention mentioned above are intended for illustrating the gist and scope of the present invention and do not restrict the present invention.

What is claimed is:

1. An image processing circuit, adapted to be provided in a printer controller, and operable to divide input image data having gradation values for each pixel into cells formed from a plurality of pixels and to perform screen processing on a per-cell basis, to thus convert the input image data into output image data, the image processing circuit comprising:
a cell screen processing circuit, configured to receive an input of the input image data, to extract from the input image data a cell in a predetermined shape, to determine a position of centroid of a gradation value in the cell from input gradation values of respective pixels constituting the cell, and to perform screen processing for deciding output gradation values of the respective pixels so as to cause a dot corresponding to a total of the input gradation values of the entire cell to grow, with reference to the position of the centroid, thereby outputting the output gradation values of the respective pixels;
an output raster buffer, configured to store the output gradation values of the respective pixels having been subjected to the screen processing;
a raster buffer write controller, configured to perform processing for writing the output gradation values of the respective pixel shaving been subjected to the screen processing, into the output raster buffer; and
a raster buffer read controller, configured to perform processing for reading and outputting the output gradation values of the respective pixels written into the output raster buffer.

2. The image processing circuit according to claim 1, wherein
the raster buffer write controller includes:
a shared pixel determination function for determining whether or not a pixel which is an object pixel written into the output raster buffer is a shared pixel that is a pixel overlapping with a pixel of an adjacent cell; and
a write processing function for performing, when the object pixel is not the shared pixel, processing for writing the gradation value of the pixel, which is output from the cell screen processing circuit, into the output raster buffer, and for performing, when the object pixel is the shared pixel, processing for adding the gradation value of the pixel of the adjacent cell, which is read by the raster buffer read controller, to the gradation value of the pixel, which is output from the cell screen processing circuit, thereby writing a result of addition into the output raster buffer.

3. The image processing circuit according to claim 2, wherein
the raster buffer write controller and the raster buffer read controller share an address computer configured to compute an address of a pixel which is an object to be written and an address of a pixel which is an object to be read; and
the address computer
stores a write start position indicating a position of a raster line in the output raster buffer, where writing of a cell row which is an object of processing is started, and adds an amount of vertical shift, which is a distance between cell centers, to the write start position after completion of writing of the cell row, thereby determining a write start position of a cell row which is an object of next processing,
takes, when the write start position to which the amount of vertical shift is added exceeds a position of a final raster row of the output raster buffer, as the write start position, a position determined by adding the number of the exceeded raster rows to a position of a top raster row of the output raster buffer, and
takes, after completion of writing of the cell row, as a read start position, the write start position before addition of the amount of vertical shift.

4. The image processing circuit according to claim 3, wherein
when a part of a plurality of raster rows constituting the cell row which is an object of processing exceed, at the write start position, the position of the final raster row of the output raster buffer, the address computer computes an address where gradation values of respective pixels are written while taking a write start position of the part of the raster rows as the top raster row of the output raster buffer.

5. The image processing circuit according to claim 1, wherein
the output raster buffer has a width, in a direction perpendicular to a raster direction, which is equal to at least two cells.

6. The image processing circuit according to claim 1, wherein
the cell screen processing circuit includes:
an input raster buffer, configured to receive the input of the input image data, and to store the input gradation values of the respective pixels;
a cell extract controller, configured to extract the cell in the predetermined shape from the input image data stored in the input raster buffer;
a cell buffer, configured to temporarily store the cell extracted by the cell extract controller; and
a cell screen processor, configured to determine the position of the centroid from the input gradation values of the respective pixels constituting the cell stored in the cell buffer and to perform the screen processing for determining the output gradation values of the respective pixels so as to cause the dot corresponding to the total of the input gradation values of the entire cell to grow, with reference to the position of the centroid, thereby outputting the output gradation values of the respective pixels.

7. The printer controller equipped with the image processing circuit defined in claim 5.
